(19) United States
(12) Patent Application Publication
(10) Pub. No.: US 2013/0098505 A1
(43) Pub. Date: Apr. 25, 2013

(54) CUTTING BIT FOR PRUNING TOOL

(71) Applicant: CI, LLC, Solon, OH (US)

(72) Inventor: William J. Nelson, II, Solon, OH (US)

(73) Assignee: CI, LLC, Solon, OH (US)

(21) Appl. No.: 13/654,526

(22) Filed: Oct. 18, 2012

Related U.S. Application Data
(60) Provisional application No. 61/549,274, filed on Oct. 20, 2011.

(51) Int. Cl. A01G 3/08; B27G 15/00; B23B 51/00

(52) U.S. Cl. CPC A01G 3/085; B23B 51/00; B27G 15/00
USPC 144/343; 408/229; 408/230

(57) ABSTRACT

A cutting bit for a pruning tool includes an elongate body having a first end and a second end. At least one flute extends at least part of a distance between the first end and the second end of the elongate body. A shank is located at the first end of the elongate body and is adapted for connection to an associated pruning tool. The second end of the elongate body defines a boring tip.

This application claims priority to and the benefit of U.S. Application Ser. No. 61/549,274 filed Oct. 20, 2011.

### BACKGROUND

The present disclosure relates to a cutting bit that is adapted for connection to a power source for forming a pruning tool that operates to rotate the cutting bit. It finds particular application in conjunction with pruning of branches and tree limbs, and will be described with particular reference thereto. However, it is to be appreciated that the present exemplary embodiment is also amenable to other like applications.

In horticulture, the health of trees and shrubs can be maintained by properly pruning the limbs, branches, and stems that deliver water to the leaves of the trees and shrubs. Pruning includes the practice of removing oversized and heavy growth so that water can reach new growth. Pruning also includes the removal of diseased growth and deadwood. Pruning can furthermore be used for selectively shaping the trees and shrubs.

Conventional garden tools that are used for pruning include pruning shears, loppers, and saws. Pruning shears include a type of scissor that may have a spring biased jaw. Loppers include another type of scissor with longer handles, which generally require the use of two hands. Because the shears and loppers (hereinafter collectively referred to as ‘garden scissors’) are mechanical tools, they are generally used for pruning twigs and smaller branches. A shearing action between two blades of the garden scissors cuts a select twig or branch positioned between the blades. One problem associated with garden scissors is that wounds can tend to result from the shearing action. These wounds make the tree or shrub more susceptible to infection and disease. Furthermore, resilient branches can bind between the blades and lever them apart, thus creating a risk to the user. A larger diameter twig or branch can also require considerable force from a user of the garden scissors. Further, the gardens scissor can be a difficult tool for users who are affected by conditions that reduce hand mobility and are, thus, unable to overcome the strength of the twig or branch.

Accordingly, a handsaw is often used to prune larger branches and limbs. The handsaw operates by using a back-and-forth motion, which can tend to be a more timely process as the saw teeth are designed to cut horizontally, as opposed to directly, through the wood. A powered chainsaw can also be used for penetrating and cutting through thicker limbs and tree trunks. However, power saws are bulky and heavy, as well as potentially dangerous, and are not especially designed for simple pruning of trees and shrubs.

Accordingly, there is a need for a pruning tool that is simple and safe to use and can be used on variable sized branches and limbs while also reducing the amount of force required by a user and providing a clean cut to the branch or limb.

### BRIEF DESCRIPTION

One exemplary embodiment of the present disclosure is directed toward a cutting bit adapted to being coupled to a power source for forming a pruning tool. The cutting bit includes at least one flute extending at least part of a distance between a first end and a second end of a generally elongate body. A shank is included at the first end and is adapted for connecting to a chuck situated on the pruning tool. The second end of the cutting bit can include a tip portion defined by a blunt end. The blunt end can be adapted for remaining exposed during a rotational operation of the cutting bit. The blunt end can also be adapted for connecting to a handle assembly situated on a different pruning tool embodiment.

In another exemplary embodiment of the present disclosure, a cutting bit includes at least one flute extending at least part of a distance between a first end and a second end of a generally elongate body. A shank is included at the first end and is adapted for connecting to a chuck situated on the pruning tool. The second end of the cutting bit terminates at a tip portion that is conical in shape and includes two diametrically opposed straight-edged flutes that form a generally sharp point.

Another embodiment of a cutting bit according to the present disclosure includes at least one flute extending at least part of a distance between a first end and a second end of a generally elongate body. A shank is included at the first end and is adapted for connecting to a chuck situated on the pruning tool. The second end of the cutting bit terminates at a bulbous safety component, which is adapted to provide a smooth contact surface during a rotational operation of the cutting bit.

In still another exemplary embodiment of the present disclosure, a cutting bit for a pruning tool comprises an elongate body having a first end and a second end and at least one flute extending at least part of a distance between the first end and the second end of the elongate body. A cutting surface is defined on the at least one flute. A shank is located at the first end of the elongate body and is adapted for connection to an associated pruning tool. The second end of the elongate body defines a boring tip.

In one embodiment, the second end of the elongate body is adapted for connection to an associated handle assembly attached to the associated pruning tool. In another embodiment, an end face of the second end of the elongate body comprises a pointed tip. In still another embodiment, an end face of the second end of the elongate body includes a pair of diametrically opposed flat surfaces which extend at an acute angle alpha in relation to a plane extending perpendicular to a tip of the second end. In one embodiment, the at least one flute extends helically in a left hand spiral. The at least one flute can include a pair of opposed flutes. The opposed flutes can each include helically extending cutting surfaces. The at least one flute can include a convex surface extending along a cutting edge of the cutting bit. The convex surface can extend inwardly from an outermost circumference of the at least one flute. The convex surface can, in one embodiment, be S-shaped. In one embodiment, the elongate body can include a web portion located behind a concavely shaped cutting face. An outer surface of the cutting bit can extend at an acute angle with respect to a longitudinal axis of the elongate body. The shank of the cutting bit can have a diameter which is different than a diameter of a fluted portion of the elongate body. In one embodiment, the at least one flute extends in a left handed helix for urging debris away from a user. In another embodiment, the at least one flute extends in a right handed helix.

In still another embodiment of the present disclosure, a cutting bit for a pruning tool comprises an elongate body including a first end, an intermediate portion, a second end and a longitudinal axis. A pair of opposed flutes extend helically along the longitudinal axis at the intermediate portion of the elongate body. A helical tooth is disposed along each of the pair of opposed flutes. Each helical tooth includes a cutting surface and a relief wall which intersect to form a helical cutting edge. A shank is located at a first end of the elongate body and is adapted for connection to an associated pruning tool.

In accordance with yet another embodiment of the present disclosure, a method is provided for pruning a tree or other plant. The method comprises bracing a guard against a limb of a tree or other plant or into the limb with a tip of a cutting bit and subsequently cutting the limb by moving the cutting bit in a direction substantially parallel to a diameter of the limb.

### BRIEF DESCRIPTION OF THE DRAWINGS

FIG. 1 is side elevational view of a first exemplary embodiment of a cutting bit for a pruning tool in accordance with the present disclosure;

FIG. 2 is an enlarged cross-sectional view of the pruning tool taken along line 2-2 of FIG. 1;

FIG. 3 is a side elevational view of a second exemplary embodiment of a cutting bit for a pruning tool in accordance with the present disclosure;

FIG. 4 is a side perspective view of a third exemplary embodiment of a cutting bit for a pruning tool in accordance with the present disclosure;

FIG. 5 is a side elevational view of one embodiment of a pruning tool including the cutting bit shown in FIG. 1 assembled thereon;

FIG. 6 is a side perspective exploded view of another embodiment of a pruning tool including the cutting bit shown in FIG. 4;

FIG. 7 is a side elevational view of a cutting bit according to still another embodiment of the present disclosure;

FIG. 8 is a side elevational view of the cutting bit of FIG. 7 on an enlarged scale;

FIG. 9 is a cross sectional view through the cutting bit of FIG. 7; and

FIG. 10 is an end elevational view of a front end of the cutting bit of FIG. 8.

### DETAILED DESCRIPTION

The present disclosure is directed to a cutting bit for pruning tree branches and limbs and/or shrub branches and twigs. More specifically, the cutting bit is adapted to be coupled to a power source for forming a pruning tool that is adapted to trim tree and shrub (hereinafter collectively referred to as ‘plant’) growth in one sweeping motion.

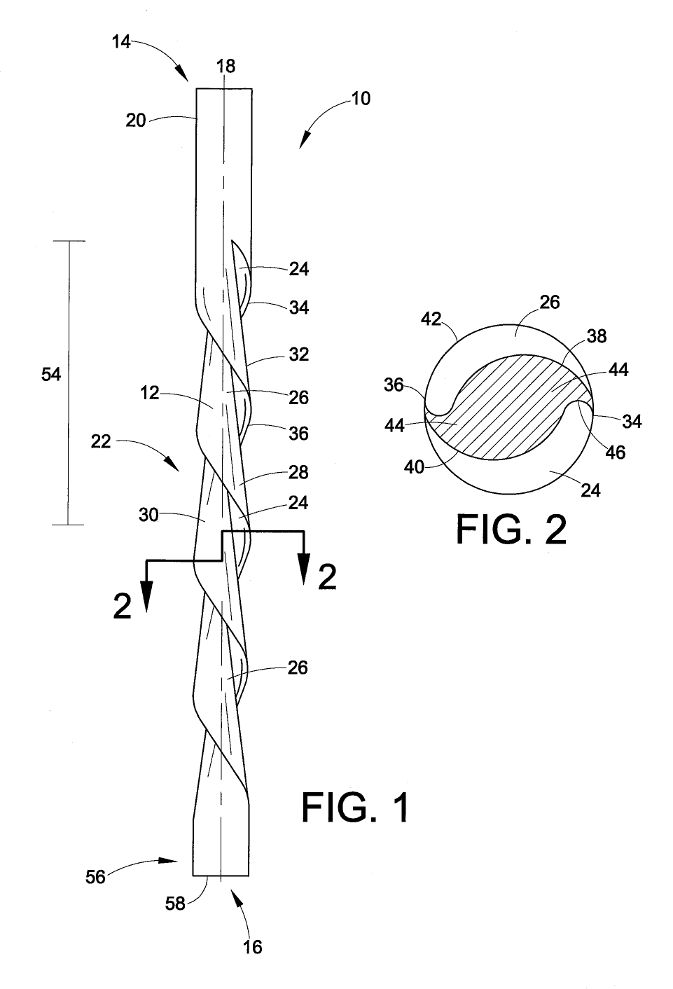

FIG. 1 illustrates a first exemplary embodiment of the cutting bit 10. The cutting bit 10 is shown as including a generally elongate body 12 extending between a first end 14 and a second end 16. The body 12 can include a generally cylindrical shape having a central axis 18 extending along a longitudinal extent of the cutting tool 10. The first end 14 of the cutting tool 10 can include a shank portion 20 that is adapted to be connected in the chuck of a later described power tool, which is used for rotating the cutting bit 10. The body 12 of the cutting bit 10 can further include an intermediate portion 22 having at least one flute. In the illustrated embodiment, the cutting bit 10 includes a first flute 24 and a second flute 26 helically extending from a location near the first end 14 to a location near the second end 16. In the illustrated embodiment, the first and second flutes 24, 26 extend in a left-hand helix downwardly toward the second end. However, a right-hand helix is also contemplated. The first and second flutes 24, 26 can include outer surfaces 28, 30, which are shown in axial profile at 32 in FIG. 1. The cutting bit 10 terminates at the second end 16.

FIG. 2 illustrates a cross-sectional profile of the cutting bit 10 shown in FIG. 1. The first and second flutes 24, 26 can include two helical cutting edges 34, 36. Each of the first and second flutes 24, 26 can include a convex portion 38, 40 extending rearwardly from the cutting edges 34, 36. Each of the convex surfaces 38, 40 can also extend inwardly from an outermost circumference 42 of the first and second flutes 24, 26 and immediately rearward of the cutting edges 34, 36 of the cutting bit 10. Each convex surface portion 38, 40 can be part of an S-shaped curve that extends in a continuous curve from one cutting edge 34, 36 to the other. The S-shaped curve can be formed by a conventional “parabolic” grinding process.

With continuing reference to FIG. 2, the “parabolic” configuration includes at least one of the first and second flutes 24, 26 having a web portion 44 situated behind a concavely shaped cutting face 46. The at least one flute 24, 26 immediately begins to curve convexly inwardly from the cutting edge 34, 36 of the opposite one of the first and second flutes 24, 26 at the outer circumference 42. The at least one flute 24, 26 continues to curve convexly inwardly in the rearward direction until it joins a concavely curved face 46, which leads to an acute angle at which the at least one flute 24, 26 joins the opposite cutting edge 34, 36. Likewise, a web portion 44 can include a convexly curved surface 38, 40, which can extend immediately inwardly from the outer circumference 42 and rearwardly from the cutting edge 34, 36. The web portion 44 can lead into the concavely shaped cutting face 46. The web portion 44 can terminate at an acute angle a at the opposite cutting edge 34, 36. One aspect of the discussed configuration is that the convex inward curvature can provide webs 44 of substantial mass behind each cutting edge 34, 36.

Returning to FIG. 1, in this manner, the first and second flutes 24, 26 form two helices that do not intertwine. Each strand and/or coil 54 of the helices tapers along the longitudinal extent of the cutting bit 10 from adjacent the second end 16 to adjacent the first end 14. However, reverse embodiments are contemplated in which a strand and/or coil 54 can taper from the first end 14 to the second end 16, such as, for example, in the embodiment illustrated in FIG. 4. In other words, each outer surface 28, 30 of the cutting bit 10 can extend at a slight, acute angle a with respect to the longitudinal axis 18 of the cutting bit 10.

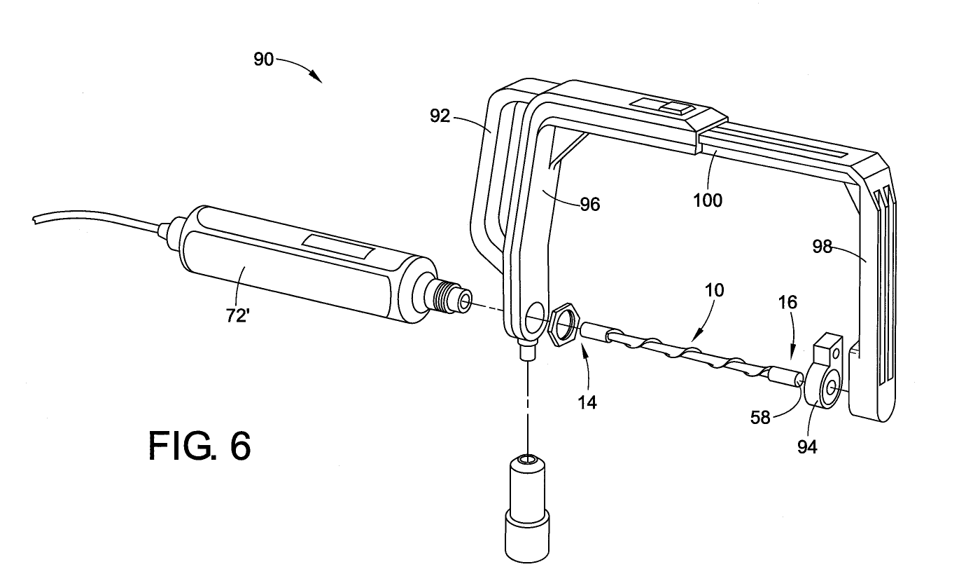

With continued reference to FIG. 1, as mentioned, the cutting tool 10 terminates at the second end 16. In one embodiment, a tip portion 56 is included at the second end 16. In the illustrated embodiment, the tip portion 56 includes a flat edge 58 that forms a blunt surface. More specifically, the flat edge 58 can be situated in a plane that extends perpendicular to the central axis 18. In this embodiment, the tip portion 56 can comprise a second shank portion that is adapted for being coupled to a handle assembly at a connection situated opposite the chuck included on the pruning tool. In this manner, the second shank portion may be used to connect the cutting bit 10 to a variety of different types of power operated tool, as shown in FIG. 6.

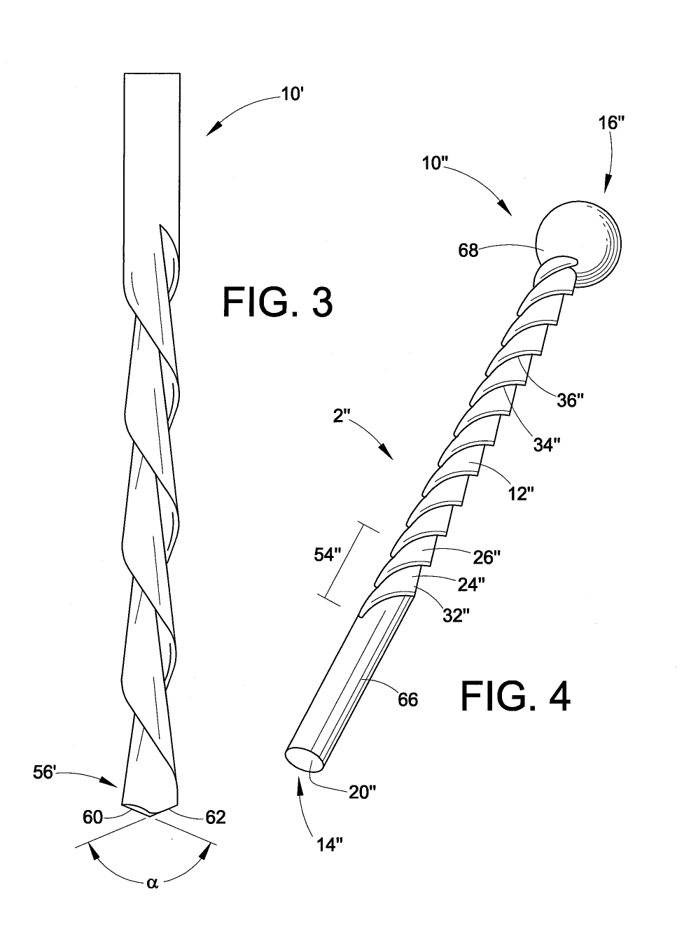

Another embodiment of a cutting tool 10′ is shown in FIG. 3 according to the present disclosure. The embodiment illustrated in FIG. 4 is similar to the embodiment discussed for FIGS. 1 and 2, except it includes a different tip portion 56′. The tip portion 56′ is conical in shape and includes two diametrically opposed straight-edged flutes 60, 62. This cutting tool embodiment may be useful for certain limb cutting purposes.

FIG. 4 illustrates another embodiment of a cutting bit 10″ according to the present disclosure. The cutting bit 10″ is shown as including a generally elongate body 12″ extending between a first end 14″ and a second end 16″. The body 12″ can include a generally cylindrical shape having a central axis extending along a longitudinal extent of the cutting tool 10″. The first end 14″ of the cutting tool 10″ can include a shank portion 20″ adapted to be connected in the chuck of a later described power tool, which is used for rotating the cutting bit 10″. The body 12″ of the cutting bit 10″ can further include an intermediate portion having at least one flute. In the illustrated embodiment, the cutting bit 10″ includes a first flute 24″ and a second flute 26″ helically extending between the first end 14″ and the second end 16″. In the illustrated embodiment, the first and second flutes 24″, 26″ extend in a right-hand helix downwardly toward the second end 16″. The first and second flutes 24″, 26″ can include outer surfaces 28″, 30″, which are shown in axial profile at 32″ in FIG. 4.

In the illustrated embodiment, the first and second flutes 24″, 26″ extend along a longitudinal extent of the body 12″. In one embodiment, the first and second flutes 24″, 26″ can extend along a limited extent portion of the body 12″. In another contemplated embodiment, the first and second flutes 24″, 26″ can extend along an entire extent of the body 12″. In the illustrated embodiment, a first coil and/or strand 54 of the first and second flutes 24″, 26″ is not situated immediately next to the shank portion 20″. Rather, a body portion 66, of generally constant diameter, is situated between the shank 20″ and a first (i.e., the most proximal) coil and/or strand 54″. This body portion 66 can include a generally uniform extent portion not including cutting edges 34″, 36″. Therefore, the second body portion 66 is adapted for spacing the power source (not shown) from the cutting edges 34″, 36″ of the first and second flutes 24″, 26″. In this manner, a reduced amount of debris can come into contact with the power source when the cutting bit 10″ is in operation.

With continued reference to FIG. 4, each coil and/or strand 54″ of the first and second flutes 24″, 26″ extends at a slight, acute angle with respect to the central axis of the cutting bit 10″. In the illustrated embodiment, the strands and/or coils 54″ each taper from the first end 14″ to the second end 16″. The cutting bit 10″ terminates near the second end 16″. In the illustrated embodiment, the first and second flutes 24″, 26″ extend along the intermediate portion 22″ of the body 12″ and terminate adjacent the second end 16″.

With continued reference to FIG. 4, in the illustrated embodiment, a bulbous safety component 68 is included at the second end 16″. The bulbous safety component 68 includes a generally spherical profile. The rounded surface of the spherical profile provides a smooth contact surface that is generally exposed during a powered, rotational operation of the cutting bit 10″. However, there is no limitation made herein directed toward a profile or shape of the safety component 68. What is desirable is that the safety component 68 prevents a contact between a hand of the user and the rotating cutting edges 34″, 36″ situated toward the second end 16″ of the cutting bit 10″.

In the illustrated embodiment, the safety component 68 is shown as including a (maximum) diameter that is greater than a diameter of the generally cylindrical profile of the elongate body 12″. However, there is no limitation made herein directed toward the diameter or length of the safety component 68. The round shape of the bulbous safety component 68 includes no sharp edges, corners, or surface regions. In this manner, one aspect of the cutting bit 10″ including the safety component 68 is a reduced risk of the rotating cutting bit 10″ penetrating any undesirable material. Accordingly, another aspect of the safety component 68 is that it reduces a risk of injury to a user who may come into direct contact with the second end 16″ of the cutting bit 10″ during an operating of the pruning tool because the cutting bit does not have a distal end with sharp points defined by fluted tip portions or corners defined by flat-edged tip portions.

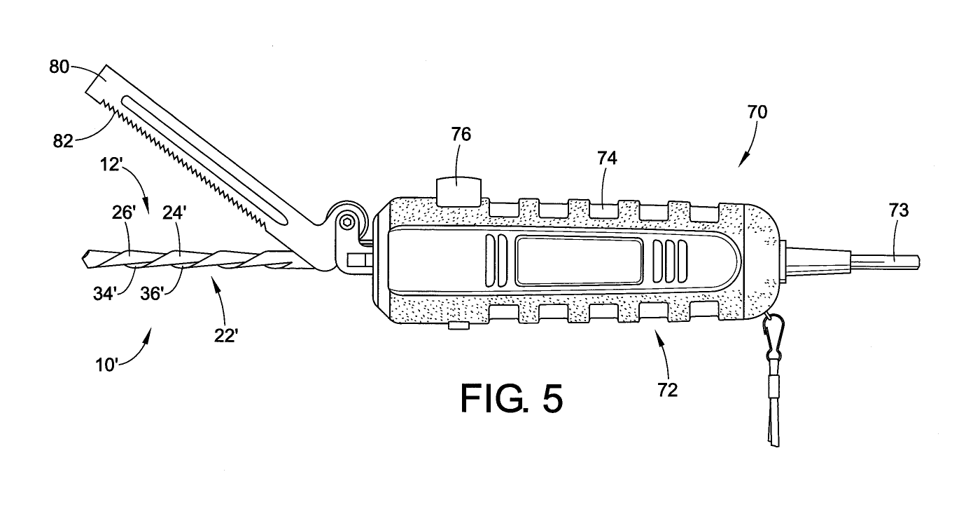

FIG. 5 illustrates a cutting bit 10′ of the present disclosure implemented in one embodiment of a pruning tool 70. More specifically, the cutting bit 10′ embodiment illustrated in FIG. 3 is shown attached to a power tool 72 for forming the pruning tool 70. The power tool 72 contains a mechanical driving component, such as, for example, a motor (not shown) that selectively drives a rotation of the cutting bit 10′. The motor can be an electrically powered motor which can be powered via batteries or via a power cord 73 as shown. The power tool 72 can further include a handle 74 and a switch 76 for selectively operating the pruning tool 70. In operation, a user grasps the handle 74 and depresses the switch 76 for initiating a rotation of the cutting bit 10′. The user can then trim a branch or limb by slicing across a cross-sectional profile of the branch or limb. The user can trim the branch or limb by urging the intermediate portion 22′ of the body 12′ across the cross-sectional profile of the branch and limb. In this manner, the cutting edges 34′, 36′, as they rotate, cut through the branch and limb. The left-handed helices of the first and second flutes 24′, 26′ urge the debris downward and away from the user. In the illustrated embodiment, serrated teeth 82 on a resiliently biased guard 80 can work in conjunction with the cutting bit 10′ to assist in holding branches.

FIG. 6 illustrates the cutting bit 10 of the present disclosure implemented in another embodiment of a pruning tool 90 and an arm assembly 92, respectively. More specifically, the first and second ends 14, 16 of the cutting bit 10 (described for FIG. 1) are shown as being attached to the pruning tool 90. The flat edge 58 situated at the second end 16 is mounted in a removable bearing 94 held in the arm assembly 92. The arm assembly 92 includes a first arm portion 96 that connects with the power tool 72′. A second arm portion 98 is spaced apart from the first arm portion 96 and is adapted to connect to the second end 16 of the cutting tool 10. A third arm portion 100 connects the first and second arm portions 96, 98 and is spaced in generally parallel relation to the rotary cutting bit 10. In this manner, the user can grasp onto the arm assembly 92 and urge the cutting bit 10 of the pruning tool 90 across the desired branch and/or limb.

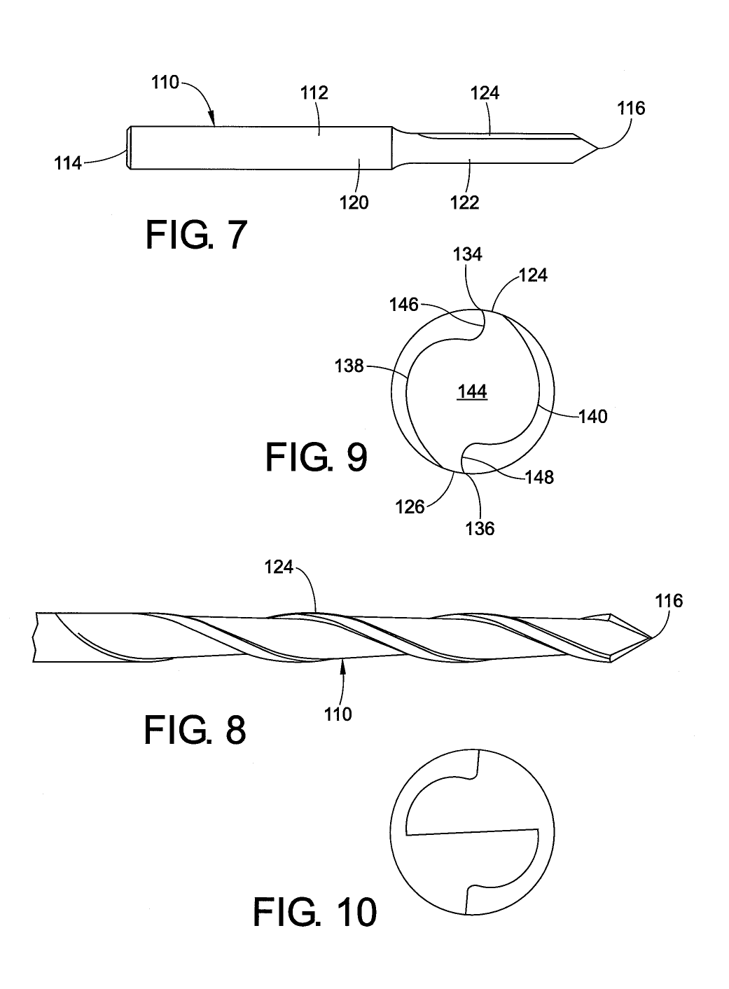

With reference now to the embodiment of FIG. 7, disclosed therein is a cutting bit 100 including a generally elongate body 112 extending between a first end 114 and a second end 116. The body 112 can include a generally cylindrical shape having a longitudinally extending axis. The first end 114 of the cutting tool can include a shank portion 120 that is adapted to be mounted in a chuck of a power tool. The body 112 of the cutting bit can further include an intermediate portion 122 on which is defined at least one flute 124. In the embodiment illustrated in FIG. 9, two such diagonally opposed flutes 124 and 126 are illustrated. The first and second flutes can extend in a left hand helix toward the second end 116 of the cutting bit 112.

Each of the first and second flutes can include a helical cutting edge 134 and 136 and can further include a convex portion 138 and 140 extending rearwardly from the respective cutting edge. A web portion 144 of the body 112 can include the convexly shaped surfaces 138 and 140, as well as the cutting edges 134 and 136. It can be seen that the first and second flutes 124 and 126 do not intertwine.

The cutting bit 110 terminates at its second end 116. In the embodiment illustrated in FIG. 7, and perhaps better seen in FIG. 8, the second end 116 is pointed so as to define a boring tip. The tip can, in one embodiment, comprise angled faces that extend at a 60° angle in relation to a longitudinal axis of the cutting bit.

In this embodiment, the cutting bed can have a diameter of about 0.25 inches with a total length of 5 inches and an intermediate body length of about 1.875 inches. It can be seen from FIG. 9 that the approximate diameter of the web portion 144 can be on the order of 0.150 inches. It can also be seen from FIG. 9 that the convex surfaces 138 and 140 terminate at the outer periphery of the cutting bit body 112, but start at the respective cutting edge 134 and 136 where they define respective cutting faces 146 and 148.

The helix on the flutes can be on the order of 25° with a radial rate of 20°. In another embodiment, the core diameter can be on the order of 0.117 inches. The flute is shallow. In one embodiment, the flute is approximately 0.035 inches in depth when the diameter of the intermediate portion of the cutting bit is about 0.1875 inches.

It should be appreciated that various lengths and diameters of bits according to the instant disclosure can be employed with a variety of hand-held powered tools in order to cut small, medium and, perhaps, large trees, as well as bushes and other vegetation.

In one embodiment, a 0.25 inch shank can be provided with a cutting portion or intermediate portion of the cutting bit having a diameter of ⅛ of an inch or 3/16 of an inch. In another embodiment, the shank portion and the intermediate portion can have the same diameter, such as 0.25 inch. In yet a third embodiment, the shank can have a 0.25 inch diameter, whereas the intermediate portion has a 5/16 inch diameter. Put another way, the shank and the intermediate portion, which contains the one or more flutes, can have the same diameter or can have different diameters, wherein the intermediate portion can have a diameter either smaller than or larger than the shank portion or have the same diameter as the shank portion.

Plant material, such as trees and shrubs can vary in size and dimension. As a result, cutting bits for pruning such plant material can also vary in combinations of diameter, overall length and length of cut. With cutting bits according to the present disclosure, the cutting surface depth, the overall length of the cutting bit and the boring tip can vary somewhat to accommodate a particular type of plant. The cutting bits are designed to make rough cuts in plant material with little resistance. The cutting bit design disclosed herein allows for lateral cutting on approach, as well as boring into a thick limb and then lateral cutting after boring into the limb. Differently sized cutting bits allow for use with small, medium and large plant material. The cutting bits can have a left hand or a right hand spiral depending on the thickness of a branch or other plant material which is meant to be pruned or cut. Cutting bits according to the instant disclosure have successfully cut tree branches having a diameter of 5½ inches.

The cutting bit 110 illustrated in FIG. 7 has a shallower depth of cut than does the cutting bit illustrated in FIG. 2, for example. An advantage of a shallow cutting depth is that the cutting bit does not bounce off the wood or other plant material which is being cut by the pruning tool. The cutting bit is elongated and has a shallow flute. This structure is advantageous for allowing the cutting bit to more easily cut into the plant material. Moreover, as one increases the bit length or diameter, one should be careful not to increase the depth of the flute. This is advantageous for two reasons. First, the cutting bit is not prone to vibrating or bouncing off the wood during the cutting process. Second, with a larger length or diameter, more cutting surface is brought to bear on the plant material which is being cut. In other words, there is more cutting surface area. It was found that when the cutting depth of the flute was increased, it was more difficult to hold the cutting bit against the wood, as the cutting bit would bounce away from the wood during the cutting process. One has to limit the depth of the spiral in order to prevent this problem.

In certain designs, when a quarter inch shank is used, the diameter of the bit can be tapered down in relation to the diameter of the shank.

In use, for a larger diameter branch of a tree, it has been found that when the guard (80 in FIG. 5) is pushed out of the way by the outer surface of the limb being cut, the cutting bit can bore a hole into the tree limb. At that point, the bit can be moved up or down in relation to the tree limb in order to cut the tree limb away from the remainder of the tree. In other words, the pruning tool cutting bit disclosed herein operates to sequentially bore a hole into the branch meant to be cut and subsequently cuts the branch.

The disclosure has been described with reference to the preferred embodiments. Obviously, modifications and alterations will occur to others upon reading and understanding the preceding detailed description. It is intended that the disclosure be construed as including all such modifications and alterations insofar as they come within the scope of the appended claims or the equivalents thereof.

What is claimed is:

1. A cutting bit for a pruning tool comprising:
an elongate body including a first end and a second end;
at least one flute extending at least part of a distance between the first end and the second end of the elongate body;
a cutting surface defined on the at least one flute;
a shank located at the first end of the elongate body and adapted for connection to an associated pruning tool; and
wherein the second end of the elongate body defines a boring tip.

2. The cutting bit of claim 1 wherein the second end of the elongated body is adapted for connecting to an associated handle assembly attached to the associated pruning tool.

3. The cutting bit of claim 1 wherein an end face of the second end of the elongate body comprises a pointed tip.

4. The cutting bit of claim 1 wherein an end face of the second end of the elongate body includes a pair of diametrically opposed flat surfaces which extend at an acute angle alpha in relation to a plane extending perpendicular to a tip of the second end.

5. The cutting bit of claim 1 wherein the at least one flute extends helically in a left hand spiral.

6. The cutting bit of claim 5 wherein the at least one flute includes a pair of opposed flutes.

7. The cutting bit of claim 6 wherein the opposed flutes each include helically extending cutting surfaces.

8. The cutting bit of claim 5 wherein the at least one flute includes a convex surface extending along a cutting edge of the cutting bit.

9. The cutting bit of claim 8 wherein the convex surface extends inwardly from an outermost circumference of the at least one flute.

10. The cutting bit of claim 9 wherein the convex surface is part of an S-shaped curve.

11. The cutting bit of claim 1 wherein the elongate body includes a web portion located behind a concavely shaped cutting face.

12. The cutting bit of claim 1 wherein an outer surface of the cutting bit extends at an acute angle with respect to a longitudinal axis of the elongated body.

13. The cutting bit of claim 1 wherein the shank has a diameter which is different than a diameter of a fluted portion of the elongate body.

14. The cutting bit of claim 1 wherein the at least one flute extends in a left-handed helix for urging debris away from a user.

15. The cutting bit of claim 1 wherein the at least one flute extends in a right-handed helix.

16. A cutting bit for a pruning tool comprising:
an elongate body including a first end, an intermediate portion, a second end and a longitudinal axis;
a pair of opposed flutes extending helically along the longitudinal axis at the intermediate portion of the elongate body;
a helical tooth disposed along each of the pair of opposed flutes, each helical tooth including a cutting surface and a relief wall which intersect to form a helical cutting edge; and
a shank located at the first end of the elongate body and adapted for connection to an associated pruning tool.

17. A method of pruning a tree or other plant comprising:
bracing a guard against a limb of the tree or other plant;
boring into the limb with a tip of a cutting bit; and
subsequently cutting the limb by moving the cutting bit in a direction parallel to a diameter of the limb.
